(19) United States
(12) Patent Application Publication
(10) Pub. No.: US 2008/0151864 A1
(43) Pub. Date: Jun. 26, 2008

(54) Network-Synchronous Data Interface

(76) Inventors: Armin Pitzer, Krefeld (DE); Martin Renner, Mettmann (DE)

Correspondence Address: SLATER & MATSIL LLP, 17950 PRESTON ROAD, SUITE 1000, DALLAS, TX, 75252, US

(21) Appl. No.: 11/961,807

(22) Filed: Dec. 20, 2007

(30) Foreign Application Priority Data
Dec. 21, 2006 (DE) 10 2006 060 821.6

(51) Int. Cl. H04L 12/28

(52) U.S. Cl. 370/351

(57) ABSTRACT

An arrangement includes a data interface that has a data input for receiving first data packets from a synchronous network that can be connected to the data input. The arrangement also has a network terminal and a packet-oriented synchronous data connection that extends between the data interface and the network terminal. The data interface is designed to derive the clock of the data connection from the clock of the synchronous network.

This application claims priority to German Patent Application 10 2006 060 821.6 which was filed Dec. 21, 2006 and is incorporated herein by reference.

### TECHNICAL FIELD

Embodiments of the invention relates to a packet-oriented data interface between a synchronous network and a network terminal or a further synchronous or plesiochronous network.

### BACKGROUND

Synchronous networks (also referred to as networks below) in which data are transmitted using data packets are used in many areas of communication technology to transmit voice, music, images, video etc., for example. The data from the network are provided to users at data interfaces and are transmitted to the respective network terminals, for example, a PC (Personal Computer) or a television set-top box, by means of data connections. It is also possible to transmit data from a synchronous network to a network node of another synchronous network using a data interface and a data connection.

Data transmission using the data connection is typically asynchronous. The availability of a highly accurate system clock at the network terminal or at the network node of the other network is required for particular applications or in the case of particular transmission methods. In this case, the packet-oriented data interface uses highly accurate local clock generators or a GPS (Global Positioning System) clock receiver, for example, to provide a highly accurate network-synchronous clock which satisfies the respective interface requirements with regard to jitter and long-term jitter (wander). This clock is transmitted from the data interface to the network terminal or the network node of the other, synchronous network using complicated methods (for example, time-stamp methods for clock synchronization).

Against this background, there is the need to provide other, possibly simpler ways of providing the network clock in the network terminal or at the network node of the other synchronous network.

### BRIEF DESCRIPTION OF THE DRAWINGS

Exemplary embodiments of the invention are explained below by way of example using the drawings, in which:

FIG. 1 shows a schematic block diagram of a synchronous network which is coupled to a network terminal by means of a data interface;

FIG. 2 shows a schematic block diagram of a synchronous network which is coupled to a network node of another synchronous or plesiochronous network by means of a data interface;

FIG. 3 shows a block diagram of a data interface;

FIG. 4 shows a flowchart for explaining method steps for transmitting data from a synchronous network to a network terminal or a network node of another synchronous network via a data interface; and

FIG. 5 shows an exemplary embodiment in which the synchronous network is implemented using a GPON (Gigabit Passive Optical Network).

### DETAILED DESCRIPTION OF ILLUSTRATIVE EMBODIMENTS

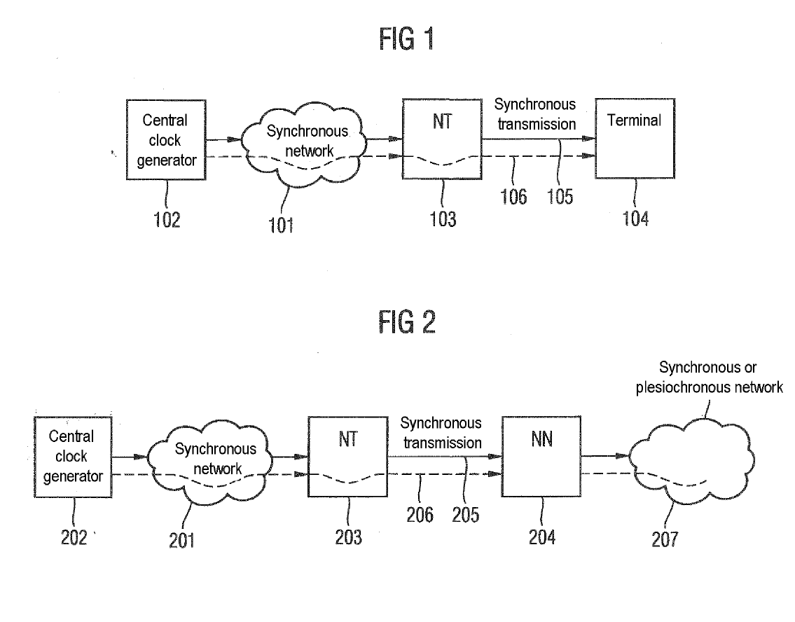

FIG. 1 shows a synchronous network 101 which is clocked by a central clock generator 102. In a synchronous network, there is a universal continuous time clock which is predefined by the central clock generator 102 and applies to all technical devices (for example, network nodes, network terminations) in the network.

According to FIG. 1, the synchronous network 101 comprises a data interface 103. The data interface 103 is a network termination (NT), that is to say a technical device of the synchronous network 101 to which a network terminal 104 is connected. It is, therefore, also referred to as a user interface. In this case, the data are transmitted between the network termination 103 and the network terminal 104 using a data connection 105 which implements synchronous transmission between the network termination 103 and the network terminal 104. The clock for synchronous transmission using the data connection 105 is derived by the network termination 103 from the central clock of the synchronous network 101. This is illustrated using the dashed line 106 which extends from the synchronous network 101, through the network termination 103, to the network terminal 104 via the synchronous data connection 105. As a result, the network terminal 104 is synchronized with the central clock in the synchronous network 101 and can be used for applications in which the availability of a highly accurate system clock is required. The network terminal 104 may be, for example, a PC, a mobile radio base station or a television set-top box.

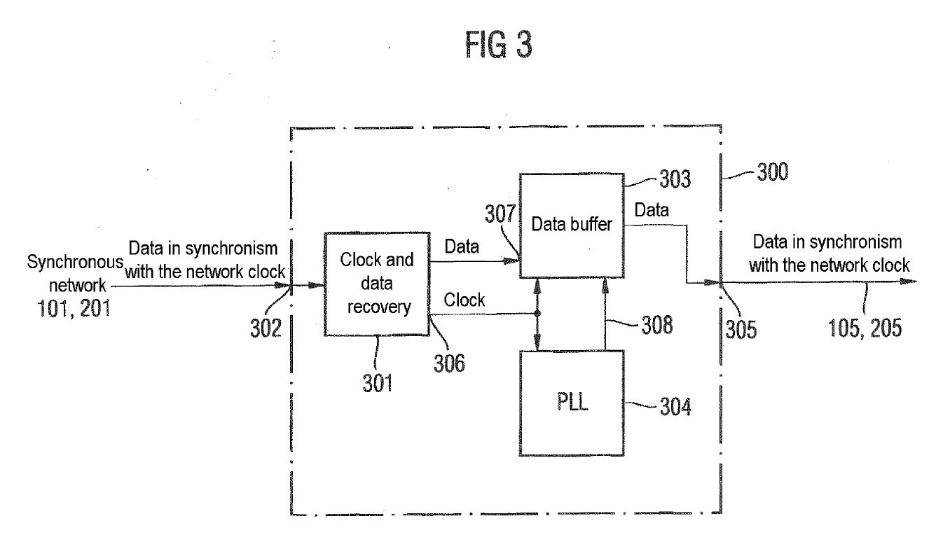

As regards the synchronous network 201, the central clock generator 202 and the network termination 203, FIG. 2 corresponds to the arrangement illustrated in FIG. 1. There is a data connection 205 between the network termination 203 and a network node 204 (NN) of a further synchronous network 207.

The network termination 203 operates in the same manner as the network termination 103. That is to say the network termination 203 derives the clock for the synchronous data connection 205 from the central clock of the synchronous network 201. The data which are transmitted with this derived clock using the data connection 205 are received by the network node 204 and are fed into the further synchronous or plesiochronous network 207. As a result of the fact that the central clock of the synchronous network 201 is derived in the network termination 203, the synchronous data connection 205 and the further synchronous network 207 are synchronized with the central clock of the synchronous network 201. Clock transmission from the synchronous network 201 to the network node (NN) 204 of the further synchronous network 207 via the network termination 203 and the synchronous data connection 205 is illustrated using the dashed line 206. One advantage of the inventive clock derivation process in the network terminations 103, 203 over conventional generation of the transmission clock using a local reference clock is that the clock derivation process can be fully implemented in an integrated circuit, whereas a local reference clock which is generated in accordance with the conventional procedure has to be provided off-chip by an external crystal clock generator.

Both in the arrangement according to FIG. 1 and in the arrangement according to FIG. 2, the clock derivation process in the data interface (network termination 103 or 203) results in the bit clock on the data connection 105, 205 being in a fixed ratio to the bit clock in the synchronous network 101, 201 which is predefined by the central clock generator 102, 202. The clock boundary which exists in conventional arrangements with local reference clock generation in the network terminations 103, 203 is thus eliminated. This is because, unlike in conventional comparable arrangements, a local reference clock is not required in the network terminations 103, 203 since the transmission clock is generated by deriving the central clock from the synchronous network 101, 201.

The arrangements shown in FIGS. 1 and 2 have the feature in common that the synchronous network 101, 201 is a packet-oriented network, that is to say data are transmitted using predefined first data packets. Data transmission using the synchronous data connection 105, 205 is likewise effected in a packet-oriented manner, the second data packets used in this case being able to be different to the first data packets as regards to the data packet format or the data packet structure.

The synchronous network 101, 201 may be a line-based (optical or electrical lines) network or a wireless network. Such synchronous networks 101, 201 in which the central clock of the synchronous network 101, 201 is transmitted to a network terminal or another network using an asynchronous data connection in the case of conventional systems are, for example, SONET (Synchronous Optical Network), SDH (Synchronous Digital Hierarchy) or PON (Passive Optical Network), including APON (ATM Passive Optical Network), BPON (Broadband Passive Optical Network), GPON (Gigabit Passive Optical Network) and EPON (Ethernet Passive Optical Network), including 10G EPON. Optical networks may also partially contain electrical components and transmission paths.

SDH and SONET are widespread synchronous networks. SDH is standardized in the ITU (International Telecommunications Union) G.707, G.708, G.793 and G.803 standards. SONET is standardized in Telcordia GR-253-CORE. Both network standards use data frames with a time duration of 125 μs, the structure of the data frames being different. PON likewise uses a fixed TDMA (Time Division Multiplex Access) structure. APON and BPON are standardized in the ITU-T G.983 standard. GPON is defined in the ITU-T G.984 standard and EPON is defined in the IEEE 802.3ah standard. 10G EPON is currently being standardized and is also known as XEPON or 10-GEPON.

FIG. 3 shows the structure of a data interface 300 (user interface) which can be used both as a network termination 103 in FIG. 1 and as a network termination 203 in FIG. 2. The data interface 300 has a clock and data recovery circuit 301 which is connected to the synchronous network 101, 201 by means of an input 302. The data interface 300 also comprises a data buffer 303 and a PLL (Phase-Locked Loop) circuit 304. An output 305 of the data buffer 303 is connected to the synchronous data connection 105, 205.

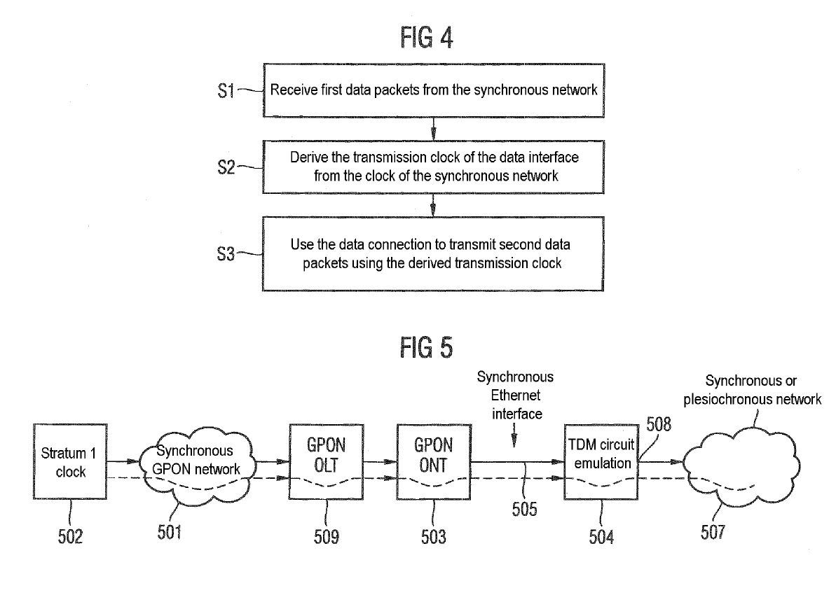

The method of operation of the data interface 300 is explained below using FIGS. 3 and 4.

The clock and data recovery circuit 301 receives first data packets from the synchronous network 101, 201 (step S1, FIG. 4). On the one hand, the clock and data recovery circuit 301 recovers the clock of the synchronous network 101, 201 from the data stream arriving at the input 302. The clock is output at an output 306 of the clock and data recovery circuit 301 and is used both to clock an input 307 of the data buffer 303 and as a reference clock for controlling the PLL circuit 304. On the other hand, the clock and data recovery circuit 301 detects the data of the data stream arriving at the input 302 and passes these data to the input 307 of the data buffer 303.

The PLL circuit 304 is used to derive the transmission clock for the data interface 300 from the received reference clock (that is to say the recovered central clock of the synchronous network 101, 201). The operation of deriving the transmission clock for the data interface 300 is illustrated in step S2 in FIG. 4. In this case, the PLL circuit 304 can multiply or divide the bit clock or the data rate. The PLL circuit 304 has a transmission clock output 308 which clocks the output 305 of the data buffer 303. The data at the output of the data interface 300 are thus output with the transmission clock generated by the PLL circuit 304 (which, as described, is derived from the clock of the synchronous network 101, 201) and are transmitted using the data connection 105, 205 (see step S3 in FIG. 4). In this case, the PLL circuit 304 is designed in such a manner that the requirements as regards jitter and wander are satisfied.

As already mentioned, the data that are transmitted using the data connection 105, 205 may be formatted in second data packets having a data structure that is different to the data structure of the first data packets used in the synchronous network 101, 201. In this respect, the data interface 300 may comprise a data processing device for reformatting data packets for the data connection 105, 205 (not illustrated). For example, an input data processing circuit (not illustrated) may be provided on the input side of the data buffer 303 and an output data processing circuit (not illustrated) may be provided on the output side of the data buffer 303. The input data processing circuit converts the data structure of the first data packets into an internal data format for the data buffer 303 and the output data processing circuit converts the data which have been read from the buffer memory 303 in the internal data format into the data structure of the second data packets. Irrespective of the manner and form in which data packets are reformatted in the data interface 300, derivation of the transmission clock for the synchronous data connection 105, 205 from the central clock of the synchronous network 101, 201 always ensures that the clock of the synchronous data connection 105, 205 (that is to say the transmission clock) is in a known fixed ratio, or in a ratio which can be permanently set in a variable manner, to the central clock of the synchronous network 101, 201 with a high level of accuracy.

The transmission clock obtained in the described manner is used to transmit the data received from the synchronous network 101, 201 to the network terminal 104 (see FIG. 1) or to the network node 204 (see FIG. 2) via the data interface 300. Additional lines or clock information transmitted in the data protocol (for example, time stamps, synchronization data packets) are not required between the data interface 300 and the network terminal 104 or the network node 204 and are typically not present either.

FIG. 5 shows another exemplary embodiment of an inventive arrangement which can be implemented both in the manner of the arrangement shown in FIG. 1 and in the manner of the arrangement shown in FIG. 2. The synchronous network 501 which is clocked by a central clock generator 502 is explained using the example of a GPON network. A GPON network 501 comprises a unit 509, which is referred to as an OLT (Optical Line Termination) and is associated with the network provider, and a unit ONT (Optical Network Termination) 503 which is associated with a customer and forms a user interface which can convert the optical signal into an electrical signal or a radio signal, for example. The unit ONT 503 is connected, by means of a synchronous data connection 505, to a unit 504 which represents either a network terminal according to FIG. 1 or a network node of a further synchronous network according to FIG. 2. In the second case, the unit 504 has an output 508 by means of which the further synchronous network 507 is coupled.

The data interface (user interface) contained in the unit ONT 503 may have the structure and method of operation explained above using FIGS. 1 to 3.

The data connection 505 may be (just like the data connections 105 and 205) an Ethernet data connection, for example. A network terminal 504 typically has an Ethernet interface. Conventional Ethernet data connections are usually operated in an asynchronous manner. In the present arrangement, on account of the fact that the clock is derived from the synchronous network 501 in the unit ONT 503, the central clock of the synchronous network 501 is transmitted on the Ethernet data connection 505. The Ethernet data connection 505 is thus operated as a synchronous data connection. Consequently, the central clock of the synchronous network 501 is available to the unit 504 in the manner already described without further measures (separate transmission of clock information) being required for this purpose.

If the unit 504 is a network terminal, it can use Ethernet to determine the transmission clock of the unit ONT and thus the central clock of the synchronous network 501 and can thus execute network-synchronous applications. As already mentioned, the unit 504 may also be the node of a further synchronous network 507. The further synchronous network 507 may be, for example, a PDH (Plesiochronous Digital Hierarchy) network 507. In this case, the network node 504 carries out a TDM circuit emulation using Ethernet. That is to say the TDM data stream which arrives via the Ethernet data connection 505 and has a data rate that is in a fixed ratio to the central clock of the network 101, 201 is packed into packets for the further synchronous network 507 in the network node 504 during the TDM circuit emulation and is fed into this further synchronous network 507. In other words, the clock of the synchronous network 501 is transmitted to the further synchronous network 507 using the network-synchronous Ethernet interface in the unit ONT 503 (network termination) and the network node 504. The synchronicity of the two networks 501 and 507 is thus achieved using a synchronously operated Ethernet data connection 505 and the TDM circuit emulation that takes place in the network node 504, without complicated synchronization using external components. Connection-oriented data transmission to the network 507 can thus be achieved.

What is claimed is:

1. A communication system comprising:
a data interface that has a data input for receiving first data packets from a synchronous network;
a network terminal; and
a packet-oriented synchronous data connection that extends between the data interface and the network terminal, the data interface being designed to derive a clock of the data connection from a clock of the synchronous network.

2. The system according to claim 1, wherein the data connection comprises an Ethernet data connection.

3. The system according to claim 1, wherein the synchronous network comprises an optical network.

4. The system according to claim 1, wherein the network terminal comprises a computer or a set-top box.

5. The system according to claim 1, wherein the network terminal comprises a mobile radio base station.

6. The system according to claim 1, wherein the data interface comprises a network termination of a GPON network.

7. The system according to claim 1, wherein the data interface comprises a network termination of a SONET network or an SDH network or an APON network or a BPON network or an EPON network.

8. The system according to claim 1, wherein the data interface comprises:
a clock recovery circuit for determining the clock of the synchronous network; and
a transmission clock generation circuit for deriving the clock of the data connection from the clock of the synchronous network.

9. The system according to claim 8, wherein the entire transmission clock generation circuit is located in a single integrated circuit chip.

10. The system according to claim 9, wherein the transmission clock generation circuit comprises a phase locked loop.

11. The system according to claim 1, wherein the data interface comprises a data buffer with a data buffer input that is clocked with the clock of the synchronous network, and a data buffer output that is clocked with the clock of the data connection.

12. The system according to claim 1, wherein the data interface comprises a data processing circuit that converts data contained in one or more first data packets into second data packets for output to the data connection.

13. A communication system comprising:
a data interface that has a data input for receiving first data packets from a first synchronous network;
a network node of a second synchronous or plesiochronous network; and
a packet-oriented synchronous data connection that extends between the data interface and the network node, the data interface being designed to derive a clock of the data connection from a clock of the first synchronous network.

14. The system according to claim 13, wherein the data connection comprises an Ethernet data connection.

15. The system according to claim 13, wherein the first synchronous network comprises an optical network.

16. The system according to claim 13, wherein the network node is designed to be a network node of a PDH network.

17. The system according to claim 15, wherein the data interface comprises a network termination of a GPON network.

18. The system according to claim 13, wherein the data interface comprises a network termination of a SONET network or an SDH network or an APON network or a BPON network or an EPON network.

19. The system according to claim 13, wherein the data interface comprises:
a clock recovery circuit for determining the clock of the first synchronous network; and
a transmission clock generation circuit for deriving the clock of the data connection from the clock of the first synchronous network.

20. The system according to claim 19, wherein the entire transmission clock generation circuit is formed on a single integrated circuit chip.

21. The system according to claim 20, wherein the transmission clock generation circuit comprises a phase locked loop.

22. The system according to claim 13, wherein the data interface comprises a data buffer with a data buffer input that is clocked with the clock of the first synchronous network, and a data buffer output that is clocked with the clock of the data connection.

23. The system according to claim 13, wherein the data interface comprises a data processing circuit that converts data contained in one or more first data packets into second data packets for output to the data connection.

24. A data interface comprising:
a data input for receiving first data packets from a synchronous network that can be coupled to the data input; and
a data output that can be coupled to a packet-oriented data connection;
wherein the data interface is designed to derive a clock of the data connection from a clock of the synchronous network; and
wherein the data interface can serve as a network termination of the synchronous network.

25. A data interface comprising:
a data input for receiving first data packets from a synchronous network that can be connected to the data input;
a clock recovery circuit for determining a clock of the synchronous network;
a transmission clock generation circuit for deriving a network-synchronous transmission clock from the clock of the synchronous network; and
a data output for outputting second data packets with the network-synchronous transmission clock.

26. The data interface according to claim 25, wherein the transmission clock generation circuit comprises a phase locked loop.

27. The data interface according to claim 25, further comprising a data buffer with a data buffer input that is clocked with the clock of the synchronous network, and a data buffer output that is clocked with the network-synchronous transmission clock.

28. The data interface according to claim 25, further comprising a data processing circuit that converts data contained in one or more of the first data packets into the second data packets.

29. A method for communicating data, the method comprising:
receiving first data packets from a synchronous network;
deriving a clock from a clock of the synchronous network; and
using the derived clock to transmit second data packets containing data of the first data packets to a network terminal, the second data packets being transmitted via a packet-oriented synchronous data connection.

30. The method according to claim 29, wherein deriving the clock comprises:
recovering the clock of the synchronous network; and
generating the derived clock from the recovered clock of the synchronous network.

31. The method according to claim 30, wherein generating the derived clock comprises driving a phase locked loop with the recovered clock of the synchronous network in order to generate the derived clock.

32. The method according to claim 30, wherein the first data packets are received at an input of a data processing circuit that is clocked with the recovered clock; and
the second data packets are output to the data connection at an output of the data processing circuit, the output being clocked with the derived clock.

33. A method for generating a clock of a packet-oriented synchronous data connection, the method comprising:
receiving first data packets from a first synchronous network;
deriving a clock from the clock of the first synchronous network; and
using the derived clock to transmit second data packets containing data of the first data packets over a packet-oriented synchronous data connection to a network node of a second synchronous network.

34. The method according to claim 33, wherein the operation of deriving the clock comprises:
recovering the clock of the first synchronous network; and
generating the derived clock of the data connection from the recovered clock of the first synchronous network.

35. The method according to claim 34, wherein generating the derived clock comprises driving a phase locked loop with the recovered clock of the first synchronous network.

36. The method according to claim 34, wherein the first data packets are received at an input of a data processing circuit that is clocked with the recovered clock; and
the second data packets are output to the data connection at an output of the data processing circuit that is clocked with the derived clock of the data connection.
